(19) United States
(12) Patent Application Publication
(10) Pub. No.: US 2024/0233179 A9
(43) Pub. Date: Jul. 11, 2024

(54) CAMERA CALIBRATION APPARATUS, CAMERA CALIBRATION METHOD, AND NON-TRANSITORY COMPUTER READABLE MEDIUM

(71) Applicant: NEC CORPORATION, Minato-ku, Tokyo (JP)

(72) Inventor: Gaku NAKANO, Tokyo (JP)

(73) Assignee: NEC CORPORATION, Minato-ku, Tokyo (JP)

(21) Appl. No.: 17/768,291

(22) PCT Filed: Oct. 24, 2019
(86) PCT No.: PCT/JP2019/041681

§ 371 Date: Nov. 3, 2022

(51) Int. Cl. G06T 7/80

(52) U.S. Cl. CPC G06T 7/80; G06T 2207/20044; G06T 2207/30196

(57) ABSTRACT

In a camera calibration apparatus, a vanishing point calculation uni calculates a “first vanishing point” in the horizontal direction based on a first coordinate pair and a second coordinate pair acquired by an acquisition unit and calculates a “second vanishing point” in the vertical direction based on a third coordinate pair and a fourth coordinate pair acquired by the acquisition unit. The camera parameter calculation unit calculates a camera parameter of a camera based on the first vanishing point and the second vanishing point calculated by the vanishing point calculation unit. Each of the first coordinate pair and the second coordinate pair is related to a part of a human horizontally distributed in a world coordinate space. Each of the third coordinate pair and the fourth coordinate pair is related to a part of a human vertically distributed in the world coordinate space.

### TECHNICAL FIELD

The present disclosure relates to a camera calibration apparatus, a camera calibration method, and a non-transitory computer readable medium.

### BACKGROUND ART

In order to perform a three-dimensional analysis of an image captured by cameras, it is necessary to clarify optical characteristics of the cameras and a positional relationship between the cameras. The optical characteristics are parameters unique to each camera, and indicate, for example, a focal length, lens distortion, optical center coordinates, and so on, and are collectively referred to as internal parameters. The internal parameters are invariant unless a zoom value is changed or a lens of the camera is replaced with a different lens. The parameters representing a position of a camera refer to a rotation matrix and a translation vector and are referred to as “external parameters”. The external parameters are invariant as long as the camera is not moved relative to an origin of a world coordinate system (three-dimensional coordinates). If these internal and external parameters are known, size and length of a subject in an image can be converted into a physical distance (e.g., meters), and a three-dimensional shape of the subject can be restored. Calculating one or both of these internal and external parameters is referred to as “camera calibration”. Also, one of the internal parameters and the external parameters may be simply referred to as “camera parameters” or both of them may be simply referred to as “camera parameters” without distinguishing between the internal parameters and the external parameters.

As a method for calculating the camera parameters, for example, Tsai's method described in Non Patent Literature 1 and Zhang's method described in Non Patent Literature 2 are widely known. These methods use a calibration object (e.g., a calibration board) to calculate the camera parameters by linking world coordinates (three-dimensional coordinates) of a pattern drawn on the calibration object with image coordinates in which the pattern is observed on the image.

### CITATION LIST

### Non Patent Literature

Non Patent Literature 1: Tsai, Roger. “A versatile camera calibration technique for high-accuracy 3D machine vision metrology using off-the-shelf TV cameras and lenses.” IEEE Journal on Robotics and Automation 3.4 (1987): 323-344.
Non Patent Literature 2: Zhang, Zhengyou. “A flexible new technique for camera calibration.” IEEE Transactions on pattern analysis and machine intelligence 22 (2000).

### SUMMARY OF INVENTION

### Technical Problem

However, the method disclosed in Non Patent Literature 1 and 2 requires a large calibration object in order to calibrate a camera installed in a wide space such as outdoors which the camera observes a wide-area environment so that a field of view of the camera can be wide. For this reason, it is impossible to perform calibration in practice, or even if it is possible, it may not be convenient. For example, even if a large calibration object is prepared, it is necessary to make sure that the calibration object is not obstructed by any object during shooting. For example, in the case of a road surveillance camera, it is necessary to restrict the traffic of pedestrians and cars.

An object of the present disclosure is to provide a camera calibration apparatus, a camera calibration method, and a non-transitory computer readable medium that can calculate camera parameters by a more convenient method.

### Solution to Problem

In a first example aspect, a camera calibration apparatus includes:
acquisition means for acquiring a first coordinate pair including first image system coordinates of a first type part and second image system coordinates of a second type part, a second coordinate pair including third image system coordinates of the first type part and fourth image system coordinates of the second type part, a third coordinate pair including fifth image system coordinates of a third type part and sixth image system coordinates of a fourth type part, and a fourth coordinate pair including seventh image system coordinates of the third type part and eighth image system coordinates of the fourth type part, the first coordinate pair, the second coordinate pair, the third coordinate pair, and the fourth coordinate pair being extracted from a plurality of human images included in one image in which a world coordinate space is captured by a camera or included in a plurality of images captured in time series in which the world coordinate space is captured by the camera, the first type part and the second type part being horizontally distributed in the world coordinate space, and the third type part and the fourth type part being vertically distributed in the world coordinate space;
vanishing point calculation means for calculating a first vanishing point in the horizontal direction based on the first coordinate pair and the second coordinate pair and calculating a second vanishing point in the vertical direction based on the third coordinate pair and the fourth coordinate pair; and
camera parameter calculation means for calculating a camera parameter of the camera based on the first vanishing point and the second vanishing point.

In a second example aspect, a camera calibration method includes:
acquiring a first coordinate pair including first image system coordinates of a first type part and second image system coordinates of a second type part, a second coordinate pair including third image system coordinates of the first type part and fourth image system coordinates of the second type part, a third coordinate pair including fifth image system coordinates of a third type part and sixth image system coordinates of a fourth type part, and a fourth coordinate pair including seventh image system coordinates of the third type part and eighth image system coordinates of the fourth type part, the first coordinate pair, the second coordinate pair, the third coordinate pair, and the fourth coordinate pair being extracted from a plurality of human images included in one image in which a world coordinate space is captured by a camera or included in a plurality of images captured in time series in which the world coordinate space is captured by the camera, the first type part and the second type part being horizontally distributed in the world coordinate space, and the third type part and the fourth type part being vertically distributed in the world coordinate space;
calculating a first vanishing point in the horizontal direction based on the first coordinate pair and the second coordinate pair and calculating a second vanishing point in the vertical direction based on the third coordinate pair and the fourth coordinate pair; and
calculating a camera parameter of the camera based on the first vanishing point and the second vanishing point.

In a third example aspect, a non-transitory computer readable medium storing a program for causing a camera calibration apparatus to execute processing of:
acquiring a first coordinate pair including first image system coordinates of a first type part and second image system coordinates of a second type part, a second coordinate pair including third image system coordinates of the first type part and fourth image system coordinates of the second type part, a third coordinate pair including fifth image system coordinates of a third type part and sixth image system coordinates of a fourth type part, and a fourth coordinate pair including seventh image system coordinates of the third type part and eighth image system coordinates of the fourth type part, the first coordinate pair, the second coordinate pair, the third coordinate pair, and the fourth coordinate pair being extracted from a plurality of human images included in one image in which a world coordinate space is captured by a camera or included in a plurality of images captured in time series in which the world coordinate space is captured by the camera, the first type part and the second type part being horizontally distributed in the world coordinate space, and the third type part and the fourth type part being vertically distributed in the world coordinate space;
calculating a first vanishing point in the horizontal direction based on the first coordinate pair and the second coordinate pair and calculating a second vanishing point in the vertical direction based on the third coordinate pair and the fourth coordinate pair; and
calculating a camera parameter of the camera based on the first vanishing point and the second vanishing point.

### Advantageous Effects of Invention

According to the present disclosure, it is possible to provide a camera calibration apparatus, a camera calibration method, and a non-transitory computer readable medium that can calculate camera parameters by a more convenient method.

### BRIEF DESCRIPTION OF DRAWINGS

FIG. 1 is a block diagram showing an example of a camera calibration apparatus according to a first example embodiment;

FIG. 2 is a block diagram showing an example of a camera calibration apparatus according to a second example embodiment;

FIG. 3 is a flowchart showing an example of a processing operation performed by the camera calibration apparatus according to the second example embodiment;

FIG. 4 is a diagram for explaining an example of a processing operation performed by the camera calibration apparatus according to the second example embodiment;

FIG. 5 is a diagram for explaining an example of a processing operation performed by the camera calibration apparatus according to the second example embodiment;

FIG. 6 is a block diagram showing an example of a camera calibration apparatus according to another example embodiment <1>;

FIG. 7 is a block diagram showing another example of a camera calibration apparatus according to the other example embodiment <1>; and

FIG. 8 shows an example of a hardware configuration of a camera calibration apparatus.

### DESCRIPTION OF EMBODIMENTS

Example embodiments will be described below with reference to the drawings. In the example embodiments, the same or equivalent elements are denoted by the same reference signs, and repeated explanations are omitted.

### First Example Embodiment

FIG. 1 is a block diagram showing an example of a camera calibration apparatus according to a first example embodiment. A camera calibration apparatus 10 shown in FIG. 1 is an apparatus for calculating (calibrating) camera parameters used in capturing images by a single camera (not shown). In FIG. 1, the camera calibration apparatus 10 includes an acquisition unit 11, a vanishing point calculation unit 12, and a camera parameter calculation unit 13.

The acquisition unit 11 acquires a “first coordinate pair”, a “second coordinate pair”, a “third coordinate pair”, and a “fourth coordinate pair” extracted from a “plurality of human images” included in one image in which a world coordinate space is captured by the camera (not shown) or a plurality of images captured in time series in which the world coordinate space is captured by the camera (not shown). The “first coordinate pair” includes “first image system coordinates” of a “first type part” and “second image system coordinates” of a “second type part”. The “second coordinate pair” includes “third image system coordinates” of the “first type part” and “fourth image system coordinates” of the “second type part”. The “first type part” and the “second type part” are parts of a human that are horizontally distributed (arranged) in the world coordinate space. The “third coordinate pair” includes “fifth image system coordinates” of a “third type part” and “sixth image system coordinates” of a “fourth type part”. The “fourth coordinate pair” includes “seventh image system coordinates” of the “third type part” and the “eighth image system coordinates” of the “fourth type part”. The “third type part” and the “fourth type part” are parts of a human that are vertically distributed (arranged) in the world coordinate space. The particle size of the “part” may be freely defined. Each of the “first image system coordinates” to the “eighth image system coordinates” is represented by, for example, three-dimensional coordinates obtained by adding scale uncertainty to two-dimensional coordinates which define an image plane, namely, so-called “homogeneous coordinates”.

Here, for example, the first coordinate pair and the third coordinate pair include image system coordinates extracted from a “first human image” of one human. The second coordinate pair and the fourth coordinate pair are extracted from a “second human image” of another human included in the image including the first human image or from a “third human image” of the one human included in the image different from the image including the first human image.

A combination of the first and second type parts may be a combination of a left shoulder joint and a right shoulder joint, a combination of a left hip joint and a right hip joint, a combination of a left eye and a right eye, a combination of a left ear and a right ear, a combination of a left knee and a right knee, or a combination of a left ankle and a right ankle. A combination of the third and fourth type parts may be a combination of upper and lower end parts of a spine, a combination of parietal and lumbar parts, a combination of a hip and a knee (especially of a stationary human), or a combination of an elbow and a wrist.

The vanishing point calculation unit 12 calculates a “first vanishing point” in a horizontal direction based on the first coordinate pair and the second coordinate pair acquired by the acquisition unit 11, and calculates a “second vanishing point” in a vertical direction based on the third coordinate pair and the fourth coordinate pair acquired by the acquisition unit 11.

The camera parameter calculation unit 13 calculates camera parameters of the camera (not shown) based on the first vanishing point and the second vanishing point calculated by the vanishing point calculation unit 12.

As described above, according to the first example embodiment, in the camera calibration apparatus 10, the vanishing point calculation unit 12 calculates the “first vanishing point” in the horizontal direction based on the first coordinate pair and the second coordinate pair acquired by the acquisition unit 11, and calculates the “second vanishing point” in the vertical direction based on the third coordinate pair and the fourth coordinate pair acquired by the acquisition unit 11. The camera parameter calculation unit 13 calculates the camera parameters of the camera (not shown) based on the first vanishing point and the second vanishing point calculated by the vanishing point calculation unit 12.

According to the configuration of the camera calibration apparatus 10, since the camera parameters are calculated by using the image system coordinates of a predetermined part of a human, the camera parameters can be calculated by a more convenient method without requiring a calibration object.

### Second Example Embodiment

A second example embodiment relates to a more specific example embodiment.

### Configuration Example of Camera Calibration Apparatus

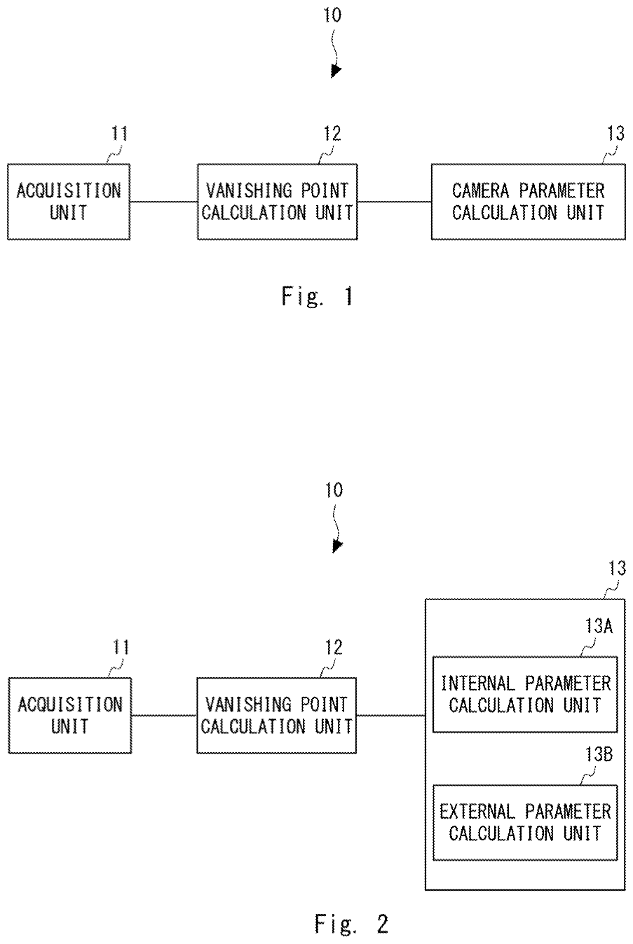

FIG. 2 is a block diagram showing an example of a camera calibration apparatus according to a second example embodiment. In FIG. 2, as in the first example embodiment, a camera calibration apparatus 10 according to the second example embodiment includes an acquisition unit 11, a vanishing point calculation unit 12, and a camera parameter calculation unit 13.

The acquisition unit 11 according to the second example embodiment acquires a “first coordinate pair”, a “second coordinate pair”, a “third coordinate pair”, and a “fourth coordinate pair” in the same manner as in the first example embodiment.

In a manner similar to the first example embodiment, the vanishing point calculation unit 12 according to the second example embodiment calculates a “first vanishing point” in the horizontal direction based on the first coordinate pair and the second coordinate pair acquired by the acquisition unit 11, and calculates a “second vanishing point” in the vertical direction based on the third coordinate pair and the fourth coordinate pair acquired by the acquisition unit 11.

For example, the vanishing point calculation unit 12 according to the second example embodiment calculates a cross product of a “first image system vector” having the first image system coordinates as an end point and a “second image system vector” having the second image system coordinates as an end point to calculate calculates a “first straight line direction vector” which is a direction vector of a first straight line passing through the first image system coordinates or the second image system coordinates. Further, the vanishing point calculation unit 12 calculates a cross product of a “third image system vector” having the third image system coordinates as an end point and a “fourth image system vector” having the fourth image system coordinates as an end point to calculate calculates a “second straight line direction vector” which is a direction vector of a second straight line passing through the third image system coordinates or the fourth image system coordinates. Furthermore, the vanishing point calculation unit 12 calculates a cross product of a “fifth image system vector” having the fifth image system coordinates as an end point and a “sixth image system vector” having the sixth image system coordinates as an end point to calculate calculates a “third straight line direction vector” which is a direction vector of a third straight line passing through the fifth image system coordinates or the sixth image system coordinates. Moreover, the vanishing point calculation unit 12 calculates a cross product of a “seventh image system vector” having seventh image system coordinates as an end point and an “eighth image system vector” having eighth image system coordinates as an end point to calculate calculates a “fourth straight line direction vector” which is a direction vector of a fourth straight line passing through the seventh image system coordinates or the eighth image system coordinates. Note that the starting point of each of the “first image system vector” to the “eighth image system vector” is an origin point of the image system.

The vanishing point calculation unit 12 calculates a cross product of the first straight line direction vector and the second straight line direction vector to calculate a “first vanishing point vector” moving toward the first vanishing point. The vanishing point calculation unit 12 calculates a cross product of the third straight line direction vector and the fourth straight line direction vector to calculate a “second vanishing point vector” moving toward the second vanishing point.

The camera parameter calculation unit 13 according to the second example embodiment includes an internal parameter calculation unit 13A and an external parameter calculation unit 13B.

The internal parameter calculation unit 13A calculates internal parameters of a camera (corresponding to a camera 20 described later) based on the first vanishing point and the second vanishing point calculated by the vanishing point calculation unit 12.

The external parameter calculation unit 13B calculates external parameters of the camera (corresponding to the camera 20 described later) based on the first vanishing point and the second vanishing point calculated by the vanishing point calculation unit 12 and the internal parameters calculated by the internal parameter calculation unit 13A.

### Operation Example of Camera Calibration Apparatus

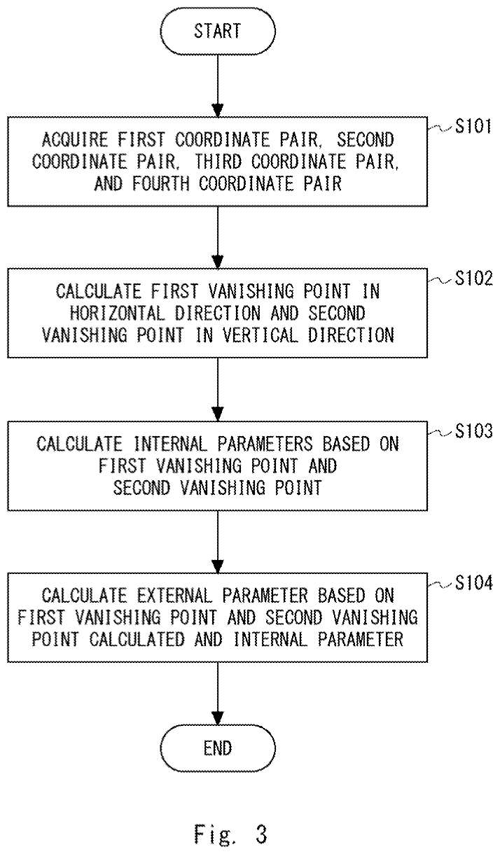

An example of a processing operation performed by the camera calibration apparatus having the above configuration will be described. FIG. 3 is a flowchart showing an example of a processing operation performed by the camera calibration apparatus according to the second example embodiment.

The acquisition unit 11 acquires the “first coordinate pair”, the “second coordinate pair”, the “third coordinate pair”, and the “fourth coordinate pair” (Step S101).

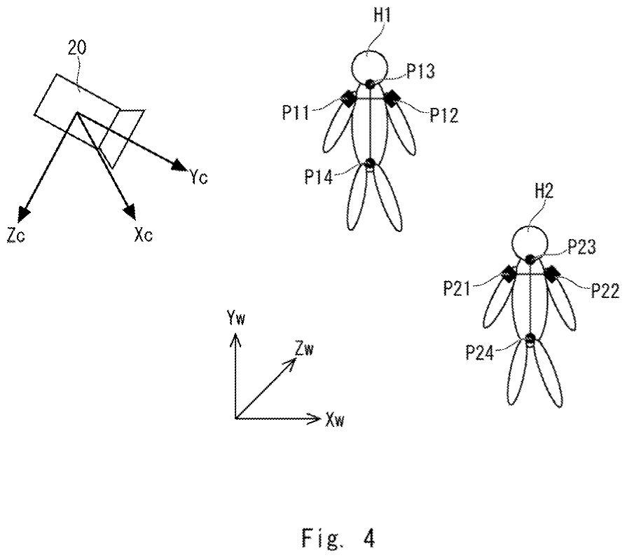

Here, the “first coordinate pair”, the “second coordinate pair”, the “third coordinate pair”, and the “fourth coordinate pair” are extracted from one image in which the world coordinate space where two humans H1 and H2 are present is captured by the camera 20 installed as shown in, for example, FIG. 4. The humans H1 and H2 are moving in the same direction in an imaging environment. In this example, the first type part and the second type part are a right shoulder and a left shoulder, respectively. The third type part and the fourth type part are an upper end part and a lower end part of a spine, respectively (e.g., a base of the neck and the coccyx, respectively).

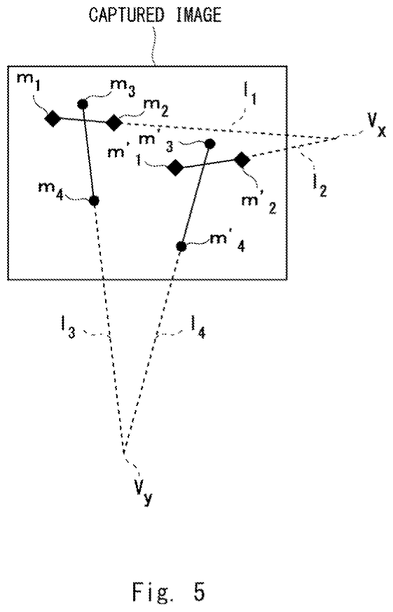

In FIG. 5, the “first coordinate pair”, the “second coordinate pair”, the “third coordinate pair”, and the “fourth coordinate pair” are shown. Specifically, image system coordinates m₁ and m₂ are the “first coordinate pair”, and the image system coordinates m₃ and m₄ are the “third coordinate pair”. The “first coordinate pair” and the “third coordinate pair” correspond to the human H1. That is, the image system coordinates m₁, the image system coordinates m₂, the image system coordinates m₃, and the image system coordinates m₄ correspond to a right shoulder P11, a left shoulder P12, an upper end part P13 of the spine, and a lower end part P14 of the spine, respectively, of the human H1. Image system coordinates m₁′ and m₂′ are the “second coordinate pair”, and image system coordinates m₃′ and m₄′ are the “fourth coordinate pair”. The “second coordinate pair” and the “fourth coordinate pair” correspond to the human H2. That is, the image system coordinates m₁′, the image system coordinates m₂′, the image system coordinates m₃′, and the image system coordinates m₄′ correspond to a right shoulder P21, a left shoulder P22, an upper end part P23 of the spine, and a lower end part P24 of the spine, respectively, of the human H2. Each of the image system coordinates m₁, the image system coordinates m₂, the image system coordinates m₃, the image system coordinates m₄, the image system coordinates m₁′, the image system coordinates m₂′, the image system coordinates m₃′, and the image system coordinates m₄′ are represented by three-dimensional coordinates obtained by adding scale uncertainty to two-dimensional coordinates which define an image plane, namely, so-called “homogeneous coordinates”. FIGS. 4 and 5 are diagrams for explaining an example of a processing operation performed by the camera calibration apparatus according to the second example embodiment.

Returning to the description of FIG. 3, the vanishing point calculation unit 12 calculates the “first vanishing point” in the horizontal direction based on the first coordinate pair and the second coordinate pair acquired by the acquisition unit 11, and calculates the “second vanishing point” in the vertical direction based on the third coordinate pair and the fourth coordinate pair acquired by the acquisition unit 11 (Step S102).

Specifically, the vanishing point calculation unit 12 calculates a cross product of a first image system vector m₁ and a second image system vector m₂ to calculate a first straight line direction vector l₁ which is a direction vector of a first straight line passing through image system coordinates m₁ or image system coordinates m₂ (see FIG. 5). That is, the first straight line direction vector l₁ is orthogonal to both the first image system vector m₁ and the second image system vector m₂. The vanishing point calculation unit 12 calculates a cross product of a third image system vector m₁′ and a fourth image system vector m₂′ to calculate a second straight line direction vector l₂ which is a direction vector of a second straight line passing through the image system coordinates m₁′ or the image system coordinates m₂′. The vanishing point calculation unit 12 calculates a cross product of a fifth image system vector m₃ and a sixth image system vector m₄ to calculate a third straight line direction vector l₃ which is a direction vector of a third straight line passing through the image system coordinates m₃ or the image system coordinates m₄. The vanishing point calculation unit 12 calculates a cross product of a seventh image system vector m₃′ and an eighth image system vector m₄′ to calculate a fourth straight line direction vector l₄ which is a direction vector of a fourth straight line passing through the image system coordinates m₃′ or the image system coordinates m₄′.

That is, the vanishing point calculation unit 12 calculates the first straight line direction vector l₁, the second straight line direction vector l₂, the third straight line direction vector l₃, and the fourth straight line direction vector l₄ using the following Mathematical Formula (1).

$$\begin{matrix}[ Mathematical Formula 1 ] & \\ \begin{matrix}{l}_{1} = {m}_{1} \times {m}_{2} \\ {l}_{2} = {m}_{1}^{′} \times {m}_{2}^{′} \\ {l}_{3} = {m}_{3} \times {m}_{4} \\ {l}_{4} = {m}_{3}^{′} \times {m}_{4}^{′}\end{matrix} \} & ( 1 )\end{matrix}$$

Here, “x” is an operator representing a cross product (vector product) of the three-dimensional vectors.

Then, the vanishing point calculation unit 12 calculates a cross product of the first straight line direction vector l₁ and the second straight line direction vector l₂ to calculate a first vanishing point vector Vₓ moving toward a first vanishing point Vₓ. The vanishing point calculation unit 12 calculates a cross product of the third straight line direction vector l₃ and the fourth straight line direction vector l₄ to calculate a second vanishing point vector V_{y} moving toward a second vanishing point V y.

That is, the vanishing point calculation unit 12 calculates the first vanishing point vector Vₓ and the second vanishing point vector V_{y} using the following Mathematical Formula (2).

$$\begin{matrix}[ Mathematical Formula 2 ] & \\ \begin{matrix}{v}_{x} = {l}_{1} \times {l}_{2} \\ {v}_{y} = {l}_{3} \times {l}_{4}\end{matrix} \} & ( 2 )\end{matrix}$$

Returning to the description of FIG. 3, the internal parameter calculation unit 13A calculates internal parameters of the camera 20 based on the first vanishing point and the second vanishing point calculated by the vanishing point calculation unit 12 (Step S103).

Here, the first vanishing point vector (the vanishing point in the horizontal direction) Vₓ and the second vanishing point vector (the vanishing point in the vertical direction) V_{y} can also be expressed by the following Mathematical Formula (3). The Mathematical Formula (3) shows that a vector having a scale different from that of the first vanishing point vector (the vanishing point in the horizontal direction) Vₓ can be obtained by projecting a unit vector of the X-axis of the world coordinate system. Similarly, the Mathematical Formula (3) shows that a vector having a scale different from that of the second vanishing point vector (the vanishing point in the vertical direction) V_{y} can be obtained by projecting a unit vector of the Y-axis of the world coordinate system.

$$\begin{matrix}[ Mathematical Formula 3 ] & \\ \begin{matrix}{v}_{x} ∝ K [ \begin{matrix}R & t\end{matrix} ] [ \begin{matrix}1 \\ 0 \\ 0 \\ 0\end{matrix} ] = {Kr}_{1} \\ {v}_{y} ∝ K [ \begin{matrix}R & t\end{matrix} ] [ \begin{matrix}0 \\ 1 \\ 0 \\ 0\end{matrix} ] = {Kr}_{2}\end{matrix} \} & ( 3 )\end{matrix}$$

Here, ∝ is an operator indicating that both sides have scale uncertainty.

K is a 3×3 upper triangular matrix representing an internal parameter, and R is a 3×3 rotation matrix representing an external parameter. Further, t is a three-dimensional translation vector which is an external parameter, and ri represents an i-th column of R.

Since the two columns of the rotation matrix R is orthogonal to each other, an inner product of the transposition of r₁ and r₂ becomes zero, and thus the following Mathematical Formula (4) is obtained.

[Mathematical Formula 4]

r₁^{T}r₂=vₓ^{T}K^{-T}K⁻¹V_{y}=0 (4)

Here, the superscript T represents a transposition of the vector or matrix.

The Mathematical Formula (4) shows that one constraint equation can be obtained from the vanishing point in the horizontal direction and the vanishing point in the vertical direction. That is, one of the internal parameters can be estimated by using the constraint equation. For example, in a digital camera, since there is no large error even if the skew is assumed to be zero and an optical center is assumed to be an image center, the only unknown number is a focal length f. In this case, since k is a diagonal matrix having [f, f, 1] as components, the focal length can be calculated by solving the Mathematical Formula (4). Note that instead of the focal length, the skew, the optical center, or the lens distortion may be used as an internal parameter to be estimated. For example, if the information about the focal length is embedded in the image, the focal length is known, and an internal parameter other than the focal length may be a parameter to be estimated.

Returning to the description of FIG. 3, the external parameter calculation unit 13B calculates the external parameter of the camera 20 based on the first vanishing point and the second vanishing point calculated by the vanishing point calculation unit 12 and the internal parameter calculated by the internal parameter calculation unit 13A (Step S104).

Specifically, the following Mathematical Formula (5) is obtained from the above Mathematical Formula (3).

$$\begin{matrix}[ Mathematical Formula 5 ] & \\ \begin{matrix}{r}_{1} = \frac{{K}^{- 1} {v}_{x}}{‖ {K}^{- 1} {v}_{x} ‖} \\ {r}_{2} = \frac{{K}^{- 1} {v}_{y}}{‖ {K}^{- 1} {v}_{y} ‖} \\ {r}_{3} = {r}_{1} \times {r}_{2} \\ R = [ {r}_{1} , {r}_{2} , {r}_{3} ]\end{matrix} \} & ( 5 )\end{matrix}$$

Here, // // represents an L2 norm of the vector.

Next, a method of calculating the translation vector will be described. In this example embodiment, the three-dimensional coordinates of each part in the world coordinate system are unknown. Therefore, a world coordinate system having any part as an origin may be defined. Here, the origin is the three-dimensional coordinates in the world coordinate system of the right shoulder P11 corresponding to the image system coordinates m₁. In this case, the projection transformation of the image system coordinate m₁ is expressed by the following Mathematical Formula (6).

$$\begin{matrix}[ Mathematical Formula 6 ] & \\ {m}_{1} ∝ K [ \begin{matrix}R & t\end{matrix} ] [ \begin{matrix}0 \\ 0 \\ 0 \\ 1\end{matrix} ] = Kt & ( 6 )\end{matrix}$$

That is, the Mathematical Formula (6) shows that when the origin in the world coordinate system is projected, the image system coordinate m₁ is obtained.

In Mathematical Formula (6), since there is scale uncertainty on both sides, the translation vector can be obtained by the following Mathematical Formula (7).

[Mathematical Formula 7]

t=K⁻¹m₁ (7)

That is, the external parameter calculation unit 13B calculates the rotation matrix R by using the Mathematical Formula (5) and calculates the translation vector by using the Mathematical Formula (7).

As described above, according to the second example embodiment, in the camera calibration apparatus 10, the vanishing point calculation unit 12 calculates the “first vanishing point” in the horizontal direction based on the first coordinate pair and the second coordinate pair acquired by the acquisition unit 11, and calculates the “second vanishing point” in the vertical direction based on the third coordinate pair and the fourth coordinate pair acquired by the acquisition unit 11. The camera parameter calculation unit 13 calculates a camera parameter of a camera (not shown) based on the first vanishing point and the second vanishing point calculated by the vanishing point calculation unit 12.

According to the configuration of the camera calibration apparatus 10, as in the first example embodiment, the vanishing point is calculated by using the image system coordinates of a predetermined part of a human, and the camera parameters are calculated based on the vanishing point, so that the camera parameter can be calculated by a a more convenient method without requiring a calibration object. The reasons for this are as follows. More specifically, when a human walks, it can be assumed that, for example, a line segment corresponding to the spine is distributed in the vertical direction and a line segment connecting both shoulders is distributed in the horizontal direction. When a plurality of pedestrians are present, it is expected that all the pedestrians move in the substantially same direction. For example, people move in one direction in places such as corridors and walking paths on roads. Therefore, even when a plurality of different pedestrians can be observed, it is possible to calculate the vanishing point by using part information about the pedestrians. Therefore, the camera parameters can be calculated by a more convenient method without requiring a calibration object.

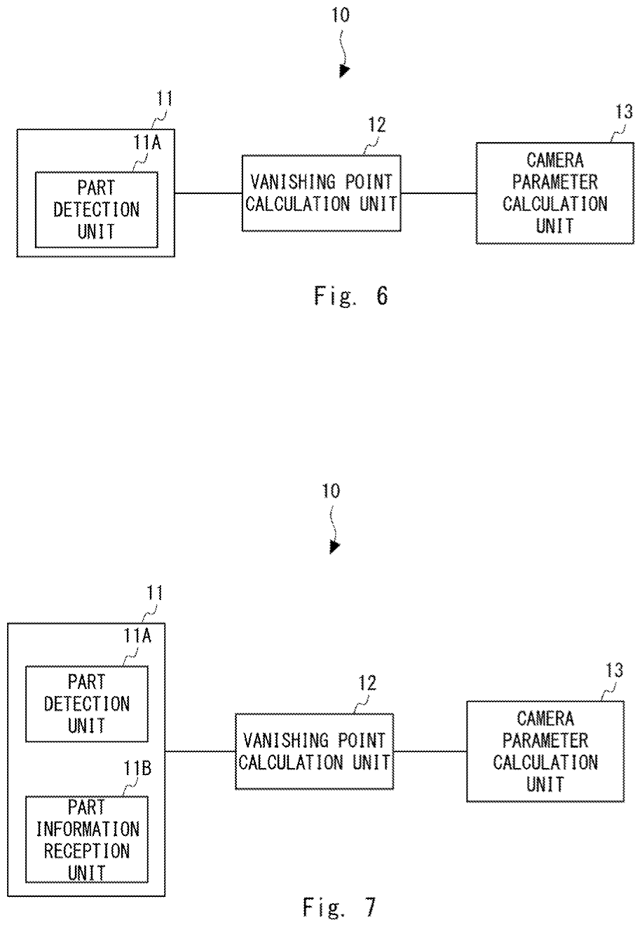

### Other Example Embodiments

<1> In the first and second example embodiments, the description has been made on the assumption that the acquisition unit 11 acquires the “first coordinate pair”, the “second coordinate pair”, the “third coordinate pair”, and the “fourth coordinate pair” extracted (detected) outside the camera calibration apparatus 10, but the present disclosure is not limited thereto. For example, as shown in FIG. 6, the acquisition unit 11 of the camera calibration apparatus 10 may include a part detection unit 11A. The part detection unit 11A acquires one image in which a world coordinate space is captured by the camera 20 or a plurality of images captured in time series in which the world coordinate space is captured by the camera 20, and detects a “first coordinate pair”, a “second coordinate pair”, a “third coordinate pair” and a “fourth coordinate pair” from a plurality of human images included in the one image or the plurality of images. FIG. 6 is a block diagram showing an example of a camera calibration apparatus according to another example embodiment <1>.

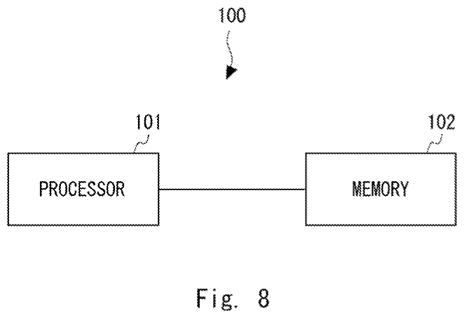

Alternatively, in the camera calibration apparatus 10, the acquisition unit 11 may include a part information reception unit 11B instead of the part detection unit 11A, or both the part detection unit 11A and the part information reception unit 11B as shown in FIG. 7. The part information reception unit 11B receives information about manually input “first coordinate pair”, “second coordinate pair”, “third coordinate pair”, and “fourth coordinate pair”. Thus, for example, it is possible to receive information about the coordinate pair not detected by the part detection unit 11A, and to receive information about the coordinate pair which is detected by the part detection unit 11A and corrected manually. FIG. 7 is a block diagram showing another example of a camera calibration apparatus according to another example embodiment <1>.

<2> In the first and second example embodiments, as a minimum configuration, the vanishing point calculation unit 12 calculates the “first vanishing point” in the horizontal direction and the “second vanishing point” in the vertical direction based on two coordinate pairs related to parts distributed horizontally in the world coordinate space and two coordinate pairs related to parts distributed vertically in the world coordinate space. However, the present disclosure is not limited to this. The vanishing point calculation unit 12 may receive three or more coordinate pairs related to parts distributed in the horizontal direction in the world coordinate space, and calculate the “first vanishing point” in the horizontal direction by the least squares method based on the three or more coordinate pairs. Likewise, the vanishing point calculation unit 12 may receive three or more coordinate pairs related to vertically distributed parts in the world coordinate space and calculate the “second vanishing point” in the vertical direction by the least squares method based on the three or more coordinate pairs. At this time, the vanishing point calculation unit 12 may use a known technique such as a so-called RANSAC (Random Sample Consensus) or a weighted least squares method in order to remove outliers and inputs with large errors to improve the estimation accuracy.

<3> FIG. 8 is a diagram showing an example of the hardware configuration of the camera calibration apparatus. In FIG. 8, the camera calibration apparatus 100 includes a processor 101 and a memory 102. The processor 101 may be, for example, a microprocessor, an MPU (Micro Processing Unit), or a CPU (Central Processing Unit). The processor 101 may include a plurality of processors. The memory 102 is composed of a combination of a volatile memory and a non-volatile memory. The memory 102 may include a storage separated from the processor 101. In this case, the processor 101 may access the memory 102 through an I/O interface (not shown).

The camera calibration apparatus 10 according to the first and second example embodiments may have the hardware configuration shown in FIG. 8. The acquisition unit 11, the vanishing point calculation unit 12, and the camera parameter calculation unit 13 of the camera calibration apparatus 10 according to the first and second example embodiments may be implemented by the processor 101 reading and executing a program stored in the memory 102. The program can be stored and provided to the camera calibration apparatus 10 using any type of non-transitory computer readable media. Examples of non-transitory computer readable media include magnetic storage media (such as floppy disks, magnetic tapes, hard disk drives, etc.), and optical magnetic storage media (e.g. magneto-optical disks). Examples of non-transitory computer readable media further include CD-ROM (Read Only Memory), CD-R, and CD-R/W. Examples of non-transitory computer readable media further include semiconductor memories. Examples of semiconductor memories include mask ROM, PROM (Programmable ROM), EPROM (Erasable PROM), flash ROM, RAM (Random Access Memory), etc. The program may be provided to the camera calibration apparatus 10 using any type of transitory computer readable media. Examples of transitory computer readable media include electric signals, optical signals, and electromagnetic waves. Transitory computer readable media can provide the program to the camera calibration apparatus 10 via a wired communication line (e.g. electric wires, and optical fibers) or a wireless communication line.

Although the present disclosure has been described with reference to the above example embodiments, the present disclosure is not limited thereto. Various modifications can be made to the configuration and details of the disclosure within the scope of the disclosure that can be understood by those skilled in the art.

### REFERENCE SIGNS LIST

10 CAMERA CALIBRATION APPARATUS
11 ACQUISITION UNIT
11A PART DETECTION UNIT
11B PART INFORMATION RECEPTION UNIT
12 VANISHING POINT CALCULATION UNIT
13 CAMERA PARAMETER CALCULATION UNIT
13A INTERNAL PARAMETER CALCULATION UNIT
13B EXTERNAL PARAMETER CALCULATION UNIT
20 CAMERA

What is claimed is:

1. A camera calibration apparatus comprising:
hardware including at least one processor and at least one memory;
an acquisition unit implemented at least by the hardware and that acquires a first coordinate pair including first image system coordinates of a first type part and second image system coordinates of a second type part, a second coordinate pair including third image system coordinates of the first type part and fourth image system coordinates of the second type part, a third coordinate pair including fifth image system coordinates of a third type part and sixth image system coordinates of a fourth type part, and a fourth coordinate pair including seventh image system coordinates of the third type part and eighth image system coordinates of the fourth type part, the first coordinate pair, the second coordinate pair, the third coordinate pair, and the fourth coordinate pair being extracted from a plurality of human images included in one image in which a world coordinate space is captured by a camera or included in a plurality of images captured in time series in which the world coordinate space is captured by the camera, the first type part and the second type part being horizontally distributed in the world coordinate space, and the third type part and the fourth type part being vertically distributed in the world coordinate space;
a vanishing point calculation unit implemented at least by the hardware and that calculates a first vanishing point in the horizontal direction based on the first coordinate pair and the second coordinate pair and calculating a second vanishing point in the vertical direction based on the third coordinate pair and the fourth coordinate pair; and
a camera parameter calculation unit implemented at least by the hardware and that calculates a camera parameter of the camera based on the first vanishing point and the second vanishing point.

2. The camera calibration apparatus according to claim 1, wherein
the vanishing point calculation unit calculates a cross product of a first image system vector having the first image system coordinates as an end point and a second image system vector having the second image system coordinates as an end point to calculate a first straight line direction vector, the first straight line direction vector being a direction vector of a first straight line passing through the first image system coordinates or the second image system coordinates,
the vanishing point calculation unit calculates a cross product of a third image system vector having the third image system coordinates as an end point and a fourth image system vector having the fourth image system coordinates as an end point to calculate a second straight line direction vector, the second straight line direction vector being a direction vector of a second straight line passing through the third image system coordinates or the fourth image system coordinates,
the vanishing point calculation unit calculates a cross product of a fifth image system vector having the fifth image system coordinates as an end point and a sixth image system vector having the sixth image system coordinates as an end point to calculate a third straight line direction vector, the third straight line direction vector being a direction vector of a third straight line passing through the fifth image system coordinates or the sixth image system coordinates,
the vanishing point calculation unit calculates a cross product of a seventh image system vector having the seventh image system coordinates as an end point and an eighth image system vector having the eighth image system coordinates as an end point to calculate a fourth straight line direction vector, the fourth straight line direction vector being a direction vector of a fourth straight line passing through the seventh image system coordinates or the eighth image system coordinates,
the vanishing point calculation unit calculates a cross product of the first straight line direction vector and the second straight line direction vector to calculate a first vanishing point vector moving toward the first vanishing point, and
the vanishing point calculation unit calculates a cross product of the third straight line direction vector and the fourth straight line direction vector to calculate a second vanishing point vector moving toward the second vanishing point.

3. The camera calibration apparatus according claim 1, wherein
the camera parameter calculation comprises:
an internal parameter calculation unit implemented at least by the hardware and that calculates an internal parameter of the camera based on the first vanishing point and the second vanishing point; and
an external parameter calculation unit implemented at least by the hardware and that calculates an external parameter of the camera based on the first vanishing point, the second vanishing point, and the internal parameter.

4. The camera calibration apparatus according claim 2, wherein
the camera parameter calculation unit comprises:
an internal parameter calculation calculating unit implemented at least by the hardware and that calculates an internal parameter of the camera based on the first vanishing point and the second vanishing point; and
an external parameter calculation unit implemented at least by the hardware and that calculates an external parameter of the camera based on the first vanishing point, the second vanishing point, and the internal parameter, and
the internal parameter calculation unit calculates the internal parameter based on the first vanishing point vector and the second vanishing point vector by using the following mathematical formula.
vₓ^{T}K⁻¹V_{y}=0 [Mathematical Formula 1]
In this mathematical formula, vₓ represents the first vanishing point vector, v_{y} represents the second vanishing point vector, K represents a matrix of the internal parameter, and T represents a vector or matrix transposition.

5. The camera calibration apparatus according to claim 1, wherein
a combination of the first type part and the second type part is a combination of a left shoulder joint and a right shoulder joint, a combination of a left hip joint and a right hip joint, a combination of a left eye and a right eye, a combination of a left ear and a right ear, a combination of a left knee and a right knee, or a combination of a left ankle and a right ankle.

6. The camera calibration apparatus according to claim 1, wherein
the combination of the third type part and the fourth type part is a combination of an upper end part and a lower end part of a spine, a combination of a parietal part and a lumbar part, a combination of a hip joint and a knee, or a combination of an elbow and a wrist.

7. The camera calibration apparatus according to claim 1, wherein
the first coordinate pair and the third coordinate pair are extracted from a first human image of one human,
the second coordinate pair and the fourth coordinate pair are extracted from a second human image of another human included in an image including the first human image or from a third human image of the one human included in an image different from the image including the first human image.

8. A camera calibration method comprising:
acquiring a first coordinate pair including first image system coordinates of a first type part and second image system coordinates of a second type part, a second coordinate pair including third image system coordinates of the first type part and fourth image system coordinates of the second type part, a third coordinate pair including fifth image system coordinates of a third type part and sixth image system coordinates of a fourth type part, and a fourth coordinate pair including seventh image system coordinates of the third type part and eighth image system coordinates of the fourth type part, the first coordinate pair, the second coordinate pair, the third coordinate pair, and the fourth coordinate pair being extracted from a plurality of human images included in one image in which a world coordinate space is captured by a camera or included in a plurality of images captured in time series in which the world coordinate space is captured by the camera, the first type part and the second type part being horizontally distributed in the world coordinate space, and the third type part and the fourth type part being vertically vertically in the world coordinate space;
calculating a first vanishing point in the horizontal direction based on the first coordinate pair and the second coordinate pair and calculating a second vanishing point in the vertical direction based on the third coordinate pair and the fourth coordinate pair; and
calculating a camera parameter of the camera based on the first vanishing point and the second vanishing point.

9. A non-transitory computer readable medium storing a program for causing a camera calibration apparatus to execute processing of:
acquiring a first coordinate pair including first image system coordinates of a first type part and second image system coordinates of a second type part, a second coordinate pair including third image system coordinates of the first type part and fourth image system coordinates of the second type part, a third coordinate pair including fifth image system coordinates of a third type part and sixth image system coordinates of a fourth type part, and a fourth coordinate pair including seventh image system coordinates of the third type part and eighth image system coordinates of the fourth type part, the first coordinate pair, the second coordinate pair, the third coordinate pair, and the fourth coordinate pair being extracted from a plurality of human images included in one image in which a world coordinate space is captured by a camera or included in a plurality of images captured in time series in which the world coordinate space is captured by the camera, the first type part and the second type part being horizontally distributed in the world coordinate space, and the third type part and the fourth type part being vertically distributed in the world coordinate space;
calculating a first vanishing point in the horizontal direction based on the first coordinate pair and the second coordinate pair and calculating a second vanishing point in the vertical direction based on the third coordinate pair and the fourth coordinate pair; and
calculating a camera parameter of the camera based on the first vanishing point and the second vanishing point.
